(19) United States
(12) Patent Application Publication
(10) Pub. No.: US 2023/0238654 A1
(43) Pub. Date: Jul. 27, 2023

(54) Bipolar Lead-Acid Battery

(71) Applicants: Furukawa Electric Co., Ltd., Tokyo (JP); The Furukawa Battery Co., Ltd., Yokohama (JP)

(72) Inventors: Hiroki Tanaka, Tokyo (JP); Yasuo Nakajima, Tokyo (JP); Kenichi Suyama, Tokyo (JP); Ayano Koide, Fukushima (JP)

(21) Appl. No.: 18/190,690

(22) Filed: Mar. 27, 2023

Related U.S. Application Data
(63) Continuation of application No. PCT/JP2021/032702, filed on Sep. 6, 2021.

(30) Foreign Application Priority Data
Sep. 30, 2020 (JP) 2020-165685

(51) Int. Cl. H01M 50/46; H01M 10/18; H01M 4/14; H01M 4/56; H01M 50/42; H01M 50/417

(52) U.S. Cl. CPC H01M 50/461; H01M 10/18; H01M 4/14; H01M 4/56; H01M 50/42; H01M 50/417

(57) ABSTRACT

A bipolar lead-acid battery is described in which the electrolyte is less likely to infiltrate the interface between a positive electrode lead layer and an adhesive layer so that deterioration in battery performance is less likely to occur. A positive electrode of a bipolar electrode of the battery includes a positive electrode lead layer disposed on one surface of a substrate. An adhesive layer is disposed between and bonds the one surface and the positive electrode lead layer. The substrate is formed of a thermoplastic resin, and the adhesive layer is a cured product of a reaction-curing type adhesive that is cured by reaction between a main agent containing an epoxy resin and a curing agent containing an amine compound. Even when immersed in sulfuric acid with a concentration of 38% by mass at a temperature of 60° C. for four weeks, the sulfuric acid does not infiltrate the interface.

### CROSS-REFERENCE TO RELATED APPLICATION

This application is a continuation of PCT/JP2021/032702, filed Sep. 6, 2021, which is incorporated herein in its entirety by reference.

### TECHNICAL FIELD

This disclosure relates to a bipolar lead-acid battery.

### BACKGROUND

A bipolar lead-acid battery includes a bipolar electrode having a positive electrode formed on one surface and a negative electrode formed on the other surface. As illustrated in FIG. 9A, a positive electrode of a conventional bipolar electrode includes a positive electrode lead layer 220 disposed on one surface of a substrate 210 formed of a resin with an adhesive layer 240 interposed therebetween, and a positive active material (PAM) layer disposed on the positive electrode lead layer 220 (see, for example, PCT Patent Publication No. WO 2013/073420 A1).

### SUMMARY

In the bipolar lead-acid battery as described above, the positive electrode lead layer 220 is corroded by the sulfuric acid contained in the electrolyte to form a film 260 of a corrosion product (lead oxide) on the surface of the positive electrode lead layer 220 (refer to FIG. 9B). There is a risk that the growth of the film 260 of the corrosion product causes elongation (growth) of the positive electrode lead layer 220. Then, there is a risk that the positive electrode lead layer 220 and the adhesive layer 240 are peeled off by the growth such that the electrolyte infiltrates into the interface between the positive electrode lead layer 220 and the adhesive layer 240 to cause further progression of corrosion of the positive electrode lead layer 220 by the sulfuric acid (refer to FIG. 9C). As a result, when the corrosion reaches, for example, the back surface of the positive electrode lead layer 220 (the surface facing the substrate 210), a short circuit may occur or the like, and battery performance may deteriorate in some cases.

An object of the present invention is to provide a bipolar lead-acid battery in which, even when growth occurs in a positive electrode lead layer due to corrosion caused by sulfuric acid contained in an electrolyte, the electrolyte is less likely to infiltrate into the interface between the positive electrode lead layer and an adhesive layer. As a result, deterioration in battery performance is less likely to occur.

A bipolar lead-acid battery according to an aspect of the present invention is a bipolar lead-acid battery including a bipolar electrode having a positive electrode formed on one surface of a substrate and a negative electrode formed on the other surface. The positive electrode includes a positive electrode lead layer that is formed of lead or lead alloy and disposed on the one surface of the substrate. A positive active material layer is disposed on the positive electrode lead layer, and an adhesive layer is disposed between the one surface of the substrate and the positive electrode lead layer and bonds the one surface of the substrate and the positive electrode lead layer. The substrate is formed of a thermoplastic resin, and the adhesive layer is formed of a cured product of a reaction-curing type adhesive that is cured by a reaction between a main agent containing an epoxy resin and a curing agent containing an amine compound. Even in a case where the adhesive layer is immersed in sulfuric acid with a concentration of 38% by mass at a temperature of 60° C. for four weeks, the sulfuric acid does not infiltrate into an interface between the positive electrode lead layer and the adhesive layer.

### BRIEF DESCRIPTION OF THE DRAWINGS

FIG. 1 is a cross-sectional view illustrating the structure of a first embodiment of a bipolar lead-acid battery according to the present invention.

FIG. 2 is an enlarged cross-sectional view of a bipolar electrode for describing the structure of the main part of the bipolar lead-acid battery in FIG. 1.

FIGS. 3A and 3B are explanatory diagrams illustrating a state in which even when growth occurs in a positive electrode lead layer due to corrosion caused by a sulfuric acid contained in an electrolyte in the bipolar lead-acid battery in FIG. 1, the electrolyte is prevented from infiltrating into an interface between the positive electrode lead layer and an adhesive layer.

FIG. 4 is an enlarged cross-sectional view of the bipolar electrode for explaining the structure of the main part of a second embodiment of the bipolar lead-acid battery according to the present invention.

FIG. 5 is a plan view of the bipolar electrode for explaining the structure of the main part of the bipolar lead-acid battery in FIG. 4.

FIG. 6 is an enlarged cross-sectional view of the bipolar electrode for explaining the structure of the main part of a third embodiment of the bipolar lead-acid battery according to the present invention.

FIG. 7 is an enlarged cross-sectional view of the bipolar electrode for explaining the structure of the main part of a fourth embodiment of the bipolar lead-acid battery according to the present invention.

FIG. 8 is an enlarged cross-sectional view of the bipolar electrode for explaining the structure of the main part of a fifth embodiment of the bipolar lead-acid battery according to the present invention.

FIGS. 9A, 9B, and 9C are explanatory diagrams illustrating a state in which growth occurring in a positive electrode lead layer due to corrosion caused by a sulfuric acid contained in an electrolyte in a conventional bipolar lead-acid battery results in the electrolyte infiltrating into an interface between the positive electrode lead layer and an adhesive layer.

### DETAILED DESCRIPTION

The embodiments described below show examples of the present invention. In addition, various changes or improvements can be applied to the embodiments, and forms to which such changes or improvements are applied can also be included in scope of the present invention.

### First Embodiment

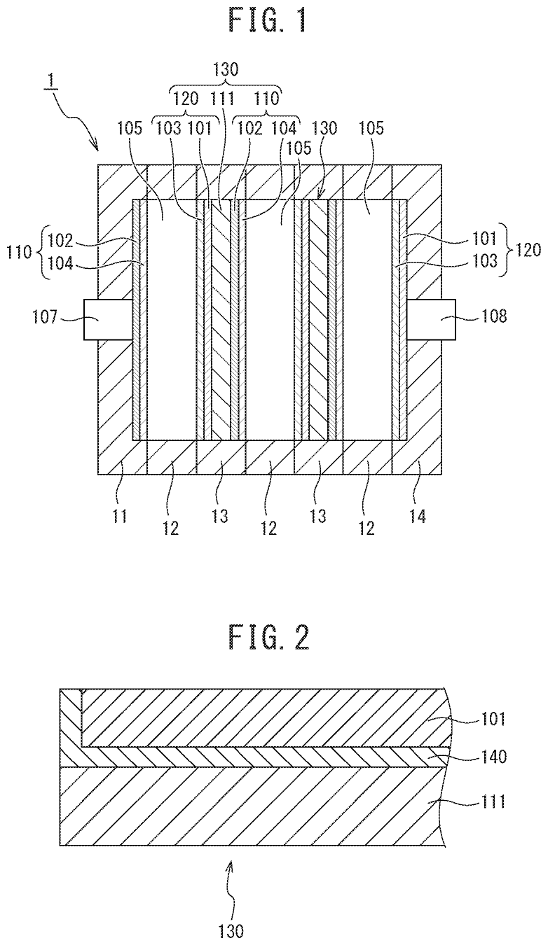

The structure of the bipolar lead-acid battery 1 of the first embodiment will be described with reference to FIGS. 1 and 2. The bipolar lead-acid battery 1 illustrated in FIG. 1 includes a first plate unit in which a negative electrode 110 is fixed to a flat plate-like first plate 11, a second plate unit in which an electrolytic layer 105 is fixed inside a frame plate-like second plate 12, a third plate unit in which a bipolar electrode 130 having a positive electrode 120 formed on one surface of a substrate 111 and the negative electrode 110 formed on the other surface is fixed inside a frame plate-like third plate 13, and a fourth plate unit in which the positive electrode 120 is fixed to a flat plate-like fourth plate 14. The substrate 111 is formed of a thermoplastic resin.

By alternately laminating the second plate unit and the third plate unit between the first plate unit and the fourth plate unit, the bipolar lead-acid battery 1 having a substantially rectangular parallelepiped shape is configured. The number of each of the second plate unit and the third plate unit to be laminated is set such that the storage capacity of the bipolar lead-acid battery 1 has a desired numerical value.

A negative electrode terminal 107 is fixed to the first plate 11, and the negative electrode 110 fixed to the first plate 11 and the negative electrode terminal 107 are electrically connected.

A positive electrode terminal 108 is fixed to the fourth plate 14, and the positive electrode 120 fixed to the fourth plate 14 and the positive electrode terminal 108 are electrically connected.

The electrolytic layer 105 is formed of, for example, a glass fiber mat impregnated with an electrolyte containing sulfuric acid.

The first to fourth plates 11, 12, 13, and 14 are formed of, for example, a well-known molding resin. The first to fourth plates 11, 12, 13, and 14 are fixed to each other by an appropriate method such that the inside is sealed so that the electrolyte does not flow out.

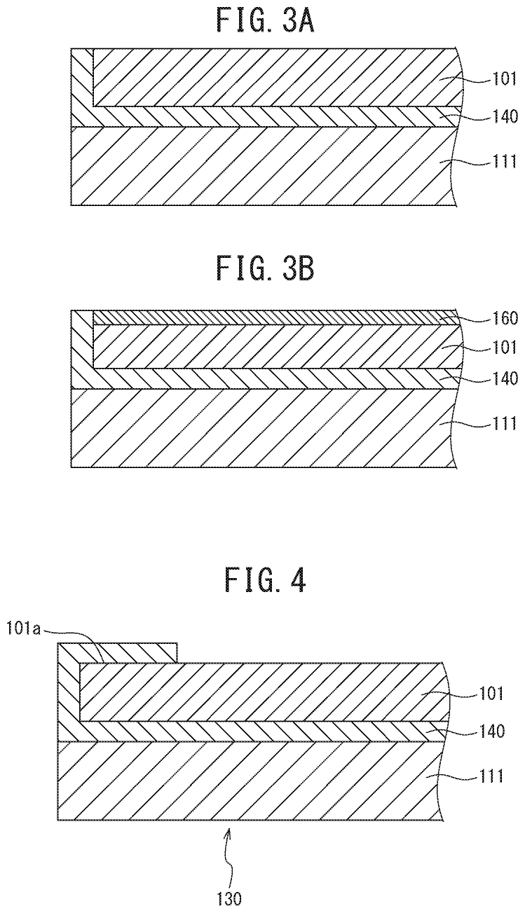

The positive electrode 120 includes a positive electrode lead layer 101 that is formed of lead or lead alloy and is disposed on the one surface of the substrate 111, a positive active material layer 103 that is disposed on the positive electrode lead layer 101, and an adhesive layer 140 that is disposed between one surface of the substrate 111 and the positive electrode lead layer 101 and bonds the one surface of the substrate 111 and the positive electrode lead layer 101. That is, the adhesive layer 140, the positive electrode lead layer 101, and the positive active material layer 103 are laminated in this order on the one surface of the substrate 111 (the surface facing upward in the paper plane in FIGS. 2, 3A, and 3B).

The negative electrode 110 includes a negative electrode lead layer 102 that is formed of lead or lead alloy and is disposed on the other surface of the substrate 111, a negative active material (NAM) layer 104 that is disposed on the negative electrode lead layer 102, and an adhesive layer that is disposed between the other surface of the substrate 111 and the negative electrode lead layer 102. The adhesive layer bonds the other surface of the substrate 111 and the negative electrode lead layer 102.

The positive electrode 120 and the negative electrode 110 are electrically connected by an appropriate method.

The negative electrode 110 and the positive active material layer 103 are not illustrated in cross-sectional views of the bipolar electrode in FIGS. 2, 3A, and 3B and the subsequent drawings to clearly show other features.

In the bipolar lead-acid battery 1 of the first embodiment having a configuration such as described above, the substrate 111, the positive electrode lead layer 101, the positive active material layer 103, the negative electrode lead layer 102, and the negative active material layer 104 constitute the bipolar electrode 130. The bipolar electrode 130 is a single electrode that functions as both a positive electrode and a negative electrode.

The bipolar lead-acid battery 1 of the first embodiment has a battery configuration in which a plurality of cell members, each formed with the electrolytic layer 105 interposed between the positive electrode 120 and the negative electrode 110, are alternately laminated and assembled so that the cell members are disposed in series.

Further, in the bipolar lead-acid battery 1 of the first embodiment, the adhesive layer 140 disposed between the one surface of the substrate 111 and the positive electrode lead layer 101 is formed of a cured product of a reaction-curing type adhesive that is cured by a reaction between a main agent containing an epoxy resin and a curing agent containing an amine compound.

Because this cured product is resistant to sulfuric acid (hereinafter, a property of being resistant to sulfuric acid may be referred to as “sulfuric acid resistance”), and the sulfuric acid does not infiltrate the interface between the positive electrode lead layer 101 and the adhesive layer 140 even in a case where the adhesive layer 140 is immersed in the sulfuric acid with a concentration of 38% by mass at a temperature of 60° C. for four weeks, the cured product is less likely to decompose, deteriorate, corrode, or the like even when the cured product comes in contact with the electrolyte. Therefore, because the positive electrode lead layer 101 and the adhesive layer 140 are firmly bonded, even when growth occurs in the positive electrode lead layer 101 due to corrosion caused by sulfuric acid contained in the electrolyte, the electrolyte is prevented from infiltrating the interface between the positive electrode lead layer 101 and the adhesive layer 140.

As described in more detail with reference to FIGS. 3A and 3B, the positive electrode lead layer 101 and the adhesive layer 140 are firmly bonded in FIG. 3A because the adhesive layer 140 is resistant to the sulfuric acid. Therefore, as illustrated in FIG. 3B, even when a film 160 of a corrosion product (lead oxide) is formed on the surface of the positive electrode lead layer 101, the growth of the film 160 of the corrosion product is suppressed by the adhesive layer 140 to prevent the film 160 of the corrosion product from infiltrating into the interface between the positive electrode lead layer 101 and the adhesive layer 140.

As a result, even when growth occurs in the positive electrode lead layer 101 due to corrosion caused by the sulfuric acid contained in the electrolyte, the positive electrode lead layer 101 and the adhesive layer 140 are less likely to be peeled off. Thus, the electrolyte is prevented from infiltrating into the interface between the positive electrode lead layer 101 and the adhesive layer 140. Therefore, it is difficult for the corrosion caused by sulfuric acid to reach the back surface of the positive electrode lead layer 101 (the surface facing the substrate 111) to cause a short circuit or the like and cause deterioration in the battery performance.

Examples of the thermoplastic resin forming the substrate 111 include an acrylonitrile-butadiene-styrene copolymer (ABS resin) and polypropylene. These thermoplastic resins have excellent moldability and excellent sulfuric acid resistance. Therefore, even when the electrolyte contacts the substrate 111, the substrate 111 is less likely to decompose, deteriorate, corrode, or the like.

Although the adhesive layer 140 is formed of a cured product obtained by curing a reaction-curing type adhesive, the reaction-curing type adhesive is a type of adhesive that is cured by mixing a main agent containing an epoxy resin and a curing agent containing an amine compound and by allowing a reaction between the main agent and the curing agent. Because such a reaction-curing type adhesive can be cured at room temperature (for example, 20° C. or higher and 40° C. or lower), the reaction-curing type adhesive can be cured at a temperature that does not easily affect the metal composition of the lead or lead alloy forming the positive electrode lead layer 101 and the negative electrode lead layer 102. Further, the reaction-curing type adhesive is less likely to adversely affect the thermoplastic resin forming the substrate 111. Further, the reaction-curing type adhesive has advantages such as high adhesiveness, long working life, and the like. It is preferable that the mixing ratio of the main agent and the curing agent in the reaction-curing type adhesive is 44 parts by mass or less of the curing agent with respect to 100 parts by mass of the main agent.

As the epoxy resin contained in the main agent, for example, at least one of a bisphenol A type epoxy resin or a bisphenol F type epoxy resin may be used. These epoxy resins may be used alone or in combination of two or more thereof.

Examples of the amine compound to be contained in the curing agent include an aliphatic polyamine compound, an alicyclic polyamine compound, and an aromatic polyamine compound. These amine compounds may be used alone or in combinations of two or more thereof.

Specific examples of the aliphatic polyamine compound include aliphatic primary amines such as triethylenetetramine (C₆H₁₈N₄) and the like, and aliphatic secondary amines such as triethylenetetramine and the like. Specific examples of the alicyclic polyamine compound include alicyclic primary amines such as isophoronediamine (C₁₀H₂₂N₂) and the like. Specific examples of the aromatic polyamine compound include aromatic primary amines such as diaminodiphenylmethane (C₁₃H₁₄N₂) and the like.

### Second Embodiment

A bipolar lead-acid battery of a second embodiment will be described in detail with reference to FIG. 4. However, because the configuration and effects of the bipolar lead-acid battery of the second embodiment are substantially the same as those of the first embodiment, only the different parts will be described, and the description of the same parts will be omitted.

In the first embodiment, the adhesive layer 140 is disposed between the one surface of the substrate 111 and the positive electrode lead layer 101 (that is, on a surface of both surfaces of the positive electrode lead layer 101 on a side facing the substrate 111), and is not disposed on a surface of both surfaces of the positive electrode lead layer 101 on a side facing the positive active material layer 103. On the other hand, in the second embodiment, as illustrated in FIG. 4, the adhesive layer 140 extends from between the substrate 111 and the positive electrode lead layer 101 to a peripheral edge portion 101a of the surface of both surfaces of the positive electrode lead layer 101 on the side facing the positive active material layer 103. The adhesive layer 140 comes into close contact with the peripheral edge portion 101a to cover the peripheral edge portion 101a.

In such a bipolar lead-acid battery of the second embodiment, because the adhesive layer 140 covers the peripheral edge portion 101a of the surface of both surfaces of the positive electrode lead layer 101 on the side facing the positive active material layer 103, even when growth occurs in the positive electrode lead layer 101 due to corrosion caused by sulfuric acid contained in the electrolyte, the electrolyte is prevented from infiltrating into the interface between the positive electrode lead layer 101 and the adhesive layer 140.

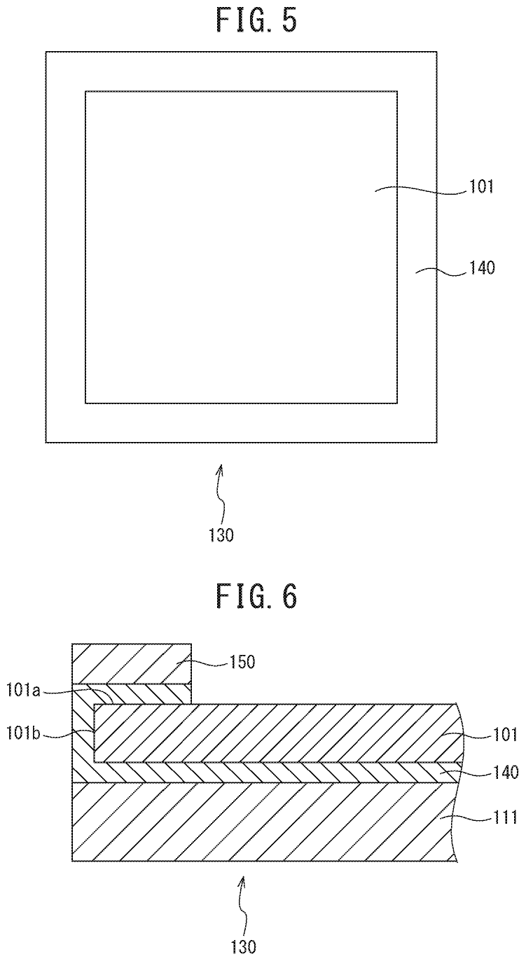

The peripheral edge portion 101a is an outer portion of the surface of both surfaces of the positive electrode lead layer 101 on the side facing the positive active material layer 103, and the peripheral edge portion 101a has a frame shape. Even when the adhesive layer 140 disposed on the surface of both surfaces of the positive electrode lead layer 101 on the side facing the positive active material layer 103 covers a part of the frame-like peripheral edge portion 101a, the above effect is exhibited. However, it is preferable that the entire frame-like peripheral edge portion 101a is covered, so that the above effect is further exhibited, and the battery performance is very unlikely to deteriorate. That is, it is preferable that the adhesive layer 140 disposed on the surface of both surfaces of the positive electrode lead layer 101 on the side facing the positive active material layer 103 may have a frame shape as illustrated in FIG. 5. In FIG. 5, the positive active material layer 103 is not illustrated.

As illustrated in FIG. 4, the adhesive layer 140 covering the peripheral edge portion 101a may be integrated with the adhesive layer 140 disposed between the one surface of the substrate 111 and the positive electrode lead layer 101. That is, the end portion of the adhesive layer 140, disposed between the one surface of the substrate 111 and the positive electrode lead layer 101, on the peripheral edge portion 101a side may extend to the peripheral edge portion 101a. Of course, the adhesive layer 140 covering the peripheral edge portion 101a may not be continuous with the adhesive layer 140 disposed between the one surface of the substrate 111 and the positive electrode lead layer 101 and may be separated.

### Third Embodiment

A bipolar lead-acid battery of a third embodiment will be described in detail with reference to FIG. 6. However, because the configuration and effects of the bipolar lead-acid battery of the third embodiment are substantially the same as those of the second embodiment, only the different parts will be described, and the description of the same parts will be omitted.

In the second embodiment, the adhesive layer 140 covers the peripheral edge portion 101a of the surface of both surfaces of the positive electrode lead layer 101 on the side facing the positive active material layer 103. However, in the third embodiment, as illustrated in FIG. 6, a covering member 150 is further disposed on the adhesive layer 140 covering the peripheral edge portion 101a. The covering member 150 is fixed to the substrate 111 with the adhesive layer 140 interposed therebetween. In this implementation, it is preferable that the covering member 150 is disposed as to press the positive electrode lead layer 101.

In such a bipolar lead-acid battery of the third embodiment, even when growth occurs in the positive electrode lead layer 101 due to corrosion caused by sulfuric acid contained in the electrolyte, the electrolyte is further prevented from infiltrating the interface between the positive electrode lead layer 101 and the adhesive layer 140.

The covering member 150 may be resistant to sulfuric acid and resistant to corrosion caused by the sulfuric acid, and examples of materials for the covering member 150 include sulfuric acid resistant resins, metals (for example, stainless steel), and ceramics.

### Fourth Embodiment

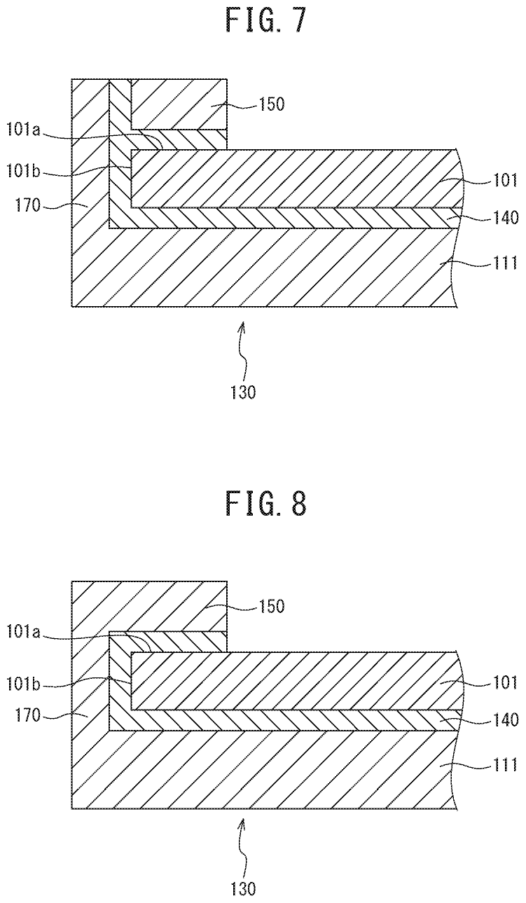

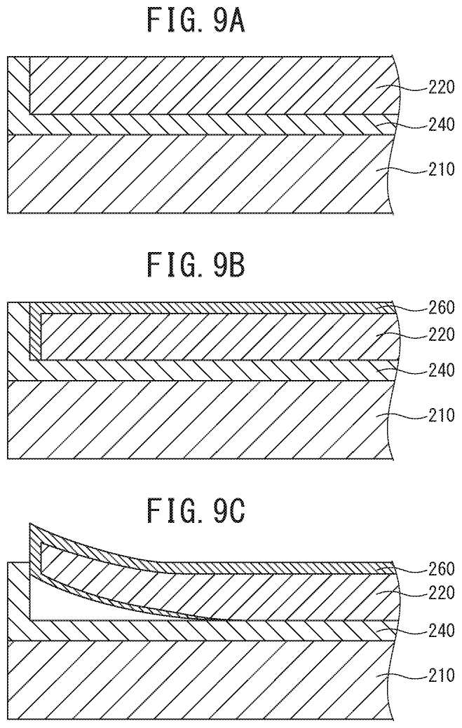

A bipolar lead-acid battery of a fourth embodiment will be described in detail with reference to FIG. 7. However, because the configuration and effects of the bipolar lead-acid battery of the fourth embodiment are substantially the same as those of the third embodiment, only the different parts will be described, and the description of the same parts will be omitted.

In the third embodiment, the substrate 111 has a flat plate shape, but in the fourth embodiment, the substrate 111 has a shape having a flange-like frame 170 at a peripheral edge tip end. That is, as illustrated in FIG. 7, a plate-like portion extends from the peripheral edge tip end of the substrate 111 in a direction perpendicular to the one surface and the other surface of the substrate 111, and this plate-like portion is the frame 170. Therefore, the frame 170 is disposed to surround a peripheral edge tip end 101b of the positive electrode lead layer 101. In addition, the frame 170 is formed of a resin.

In the bipolar lead-acid battery of the fourth embodiment, the covering member 150 is fixed to frame 170 with the adhesive layer 140 interposed therebetween. Therefore, it is easy to dispose the covering member 150 to press the positive electrode lead layer 101. When the covering member 150 is disposed to press the positive electrode lead layer 101, the growth of the film 160 of the corrosion product to the peripheral edge portion 101a is further suppressed.

The covering member 150 and the frame 170 can be fixed by an adhesive layer formed of an adhesive. The adhesive layer that fixes the covering member 150 and the frame 170 and the adhesive layer 140 that bonds the substrate 111 and the positive electrode lead layer 101 may be integrated as illustrated in FIG. 7 or may be separated.

Further, as illustrated in FIG. 7, the frame 170 and the substrate 111 may be an integrated member or may be separate members.

### Fifth Embodiment

A bipolar lead-acid battery of a fifth embodiment will be described in detail with reference to FIG. 8. However, because the configuration and effects of the bipolar lead-acid battery of the fifth embodiment are substantially the same as those of the fourth embodiment, only the different parts will be described, and the description of the same parts will be omitted.

In the fourth embodiment, the covering member 150 is a member separate from the frame 170, but in the fifth embodiment, the covering member 150 is a member integrated with the frame 170. Therefore, the covering member 150 is formed of the same resin as the frame 170. With such a configuration, it is easier to dispose the covering member 150 to press the positive electrode lead layer 101.

### EXAMPLES

In the bipolar lead storage batteries of the first to fifth embodiments, a plate-like member formed of ABS resin that can be used as the substrate 111, and a foil-like member formed of lead that can also be used as the positive electrode lead layer 101 were bonded using various adhesives to produce test pieces. A test was conducted to evaluate the sulfuric acid resistance of each test piece. That is, after heating sulfuric acid with a concentration of 38% by mass to 60° C. and immersing the test piece in the sulfuric acid for one week, two weeks, and four weeks, the bonding state of the test piece was observed, and the peeling strength when the foil-like member formed of lead was peeled off from the plate-like member formed of ABS resin was measured.

In addition, the working life was evaluated for each adhesive. Further, the coefficient of thermal expansion and the dynamic viscoelasticity of the cured product of each adhesive were measured. The measuring method will be described below.

The coefficient of thermal expansion of the cured product of the adhesive was measured using a thermomechanical analyzer (TMA) manufactured by METTLER TOLEDO. The measurement conditions are an applied load of 0.05N, a temperature range of −50° C. to 150° C., and a temperature increase rate of 10° C./min. In addition, the sample has a length of 20 mm, a width of 2 mm, and a thickness of 0.1 mm. Although the measurement was performed by a tension method with a gauge length of 10 mm, a compression method may be used in a case where the sample is small.

It is preferable to set the temperature range for measurement to be equal to or higher than the operating temperature range of the bipolar lead-acid battery. The coefficient of thermal expansion was obtained from the slope in a temperature range of −15° C. to 60° C. using the following equation. The results are shown in Table 1.

ΔL=α(T2−T1)L

In the above equation, ΔL represents the amount of thermal expansion (mm), a represents the coefficient of thermal expansion (ppm), T1 represents the temperature (° C.) before change, T2 represents the temperature (° C.) after change, and L represents the length of the sample (mm).

When the coefficients of thermal expansion of the substrate, the adhesive layer, and the positive electrode lead layer are significantly different, strain is easily caused at the interface. Thus, it is preferable to reduce the difference in coefficient of thermal expansion between the substrate, the adhesive layer, and the positive electrode lead layer.

The dynamic viscoelasticity of the cured product of the adhesive was measured using a dynamic viscoelasticity measuring device (DMA), trade name RSA-G2, manufactured by TA Instruments, and the glass transition temperature was measured from the tan 6 peak. The measurement conditions were a temperature range of −50° C. to 150° C., a frequency of 1 Hz, a gauge length of 20 mm, a strain amount of 0.2%, and a temperature increase rate of 5° C./min. Measurement was performed by the tension method. The results are shown in Table 1. Because the operating temperature range of the bipolar lead-acid battery is −15° C. to 60° C., the glass transition temperature is preferably 60° C. or higher.

A test for evaluating the sulfuric acid resistance of the test piece, and the measurement of the coefficient of thermal expansion and the dynamic viscoelasticity of the cured product of the adhesive were performed after confirming the degree of curing of the cured product of the adhesive using a Fourier transform infrared spectrophotometer. Description will be made below. By an attenuated total reflection method (ATR method) using a Fourier transform infrared spectrophotometer 660 or 610 manufactured by Agilent Technologies, Inc., the reaction rate of the epoxy group of the cured product of the adhesive was measured, and the degree of curing of the cured product of the adhesive was thus obtained.

A diamond was used as a crystal for the ATR method, and a silver-cadmium-tellurium compound (MCT) detector was used as a detector. The measurement conditions were a scanning rate of 25 kHz, an incident angle of 45 degrees, and a resolution of 4 cm⁻¹.

From the obtained spectrum, the intensity of the absorption peak (913 cm⁻¹) of the CO stretching vibration of the epoxy group and the intensity of the absorption peak (1508 cm⁻¹) of the CC stretching vibration of the phenyl group were obtained, and from the ratio of these intensities ([intensity at 913 cm⁻¹]/[[intensity at 1508 cm⁻¹]), the degree of curing of the cured product of the adhesive was obtained. Then, the test for evaluating the sulfuric acid resistance of the test piece and the measurement of the coefficient of thermal expansion and the dynamic viscoelasticity of the cured product of the adhesive were performed after confirming that the degree of curing was 0.15 or less, and the cured product was sufficiently cured.

Examples and Comparative Examples are described below.

### Example 1: Epoxy Adhesive EPIFOAM (Registered Trademark) K-9487 Manufactured by SOMAR Corporation

A main agent K-9487A contains a bisphenol A type epoxy resin, and the content of the epoxy resin in the main agent is 80% to 90% by mass. A curing agent K-9487B contains a modified aromatic polyamine compound and 4,4′-methylenedianiline, the content of the modified aromatic polyamine compound in the curing agent is 65% to 75% by mass, and the content of 4,4′-methylenedianiline is 25% to 35% by mass. In addition, the mixing ratio of the main agent and the curing agent is 44 parts by mass of the curing agent with respect to 100 parts by mass of the main agent.

The working life of this adhesive at 25° C. was 60 minutes, and the bonding work was easily performed.

When the bonding state of the test piece after immersion in the sulfuric acid for four weeks was observed, the sulfuric acid did not infiltrate into the interface between the foil-like member formed of lead and the adhesive layer, and the bonding state was good. Further, when the peeling strength was measured, it was found that the interface between the foil-like member formed of lead and the adhesive layer was peeled off, and there was almost no difference in peeling strength between before and after immersion in the sulfuric acid.

### Example 2: Epoxy Adhesive a Manufactured by Nagase ChemteX Corporation

A main agent XNR3114 contains a bisphenol A type epoxy resin and para-tertiary butyl phenyl glycidyl ether, the content of the epoxy resin in the main agent is 80% to 90% by mass, and the content of para-tertiary butyl phenyl glycidyl ether is 10% to 20% by mass.

A curing agent XNH3114 contains a modified aliphatic polyamine compound, nonylphenol, m-xylylenediamine, triethylenetetramine, and isophoronediamine. The content of the modified aliphatic polyamine compound in the curing agent is 32% by mass, the content of nonylphenol is 7.4% by mass, the content of m-xylylenediamine is 11% by mass, the content of triethylenetetramine is 15% by mass, and the content of isophoronediamine is 35% by mass.

The mixing ratio of the main agent and the curing agent is 25 parts by mass of the curing agent with respect to 100 parts by mass of the main agent.

The working life of this adhesive at 25° C. was 60 minutes, and the bonding work was easily performed.

When the bonding state of the test piece after immersion in the sulfuric acid for four weeks was observed, the sulfuric acid did not infiltrate into the interface between the foil-like member formed of lead and the adhesive layer, and the bonding state was good. Further, when the peeling strength was measured, it was found that the interface between the foil-like member formed of lead and the adhesive layer was peeled off, and there was almost no difference in peeling strength between before and after immersion in the sulfuric acid.

### Example 3: Epoxy Adhesive B Manufactured by Nagase ChemteX Corporation

A main agent XNR3106 contains a bisphenol A type epoxy resin, a bisphenol F type epoxy resin, and para-tertiary butyl phenyl glycidyl ether. The content of the bisphenol A type epoxy resin in the main agent is 40% to 50% by mass, the content of the bisphenol F type epoxy resin is 30% to 40% by mass, and the content of para-tertiary butyl phenyl glycidyl ether is 10% to 20% by mass.

A curing agent XNH3103 contains a modified polyamine compound, phenol, nonylphenol, m-xylylenediamine, triethylenetetramine, and isophoronediamine. The content of the modified polyamine compound in the curing agent is 25% by mass, the content of phenol is 4% by mass, the content of nonylphenol is 11% by mass, the content of m-xylylenediamine is 11% by mass, the content of triethylenetetramine is 23% by mass, and the content of isophoronediamine is 26% by mass.

The mixing ratio of the main agent and the curing agent is 25 parts by mass of the curing agent with respect to 100 parts by mass of the main agent.

The working life of this adhesive at 25° C. was 20 minutes, which was a short time for bonding work.

When the bonding state of the test piece after immersion in the sulfuric acid for four weeks was observed, the sulfuric acid did not infiltrate into the interface between the foil-like member formed of lead and the adhesive layer, and the bonding state was good. Further, when the peeling strength was measured, it was found that the interface between the foil-like member formed of lead and the adhesive layer was peeled off, and there was almost no difference in peeling strength between before and after immersion in the sulfuric acid.

### Comparative Example 1: Epoxy Adhesive C Manufactured by Nagase ChemteX Corporation

A main agent AV138 contains a bisphenol A type epoxy resin, a bisphenol F type epoxy resin, and silica. A curing agent HV998 contains a polyamidoamine compound and diethylenetriamine.

The mixing ratio of the main agent and the curing agent is 40 parts by mass of the curing agent with respect to 100 parts by mass of the main agent.

The working life of this adhesive at 25° C. was 35 minutes, which was a short time for bonding work.

When the bonding state of the test piece after immersion in the sulfuric acid for one week was observed, it was found that the adhesive layer interface was corroded by the sulfuric acid. Further, when the peeling strength was measured, the interface between the plate-like member formed of ABS resin and the adhesive layer was peeled off, and the peeling strength was significantly reduced by immersion in the sulfuric acid. Also, when the bonding state of the test piece after immersion in the sulfuric acid for four weeks was observed, the bonding between the foil-like member formed of lead and the adhesive layer was not maintained.

### Comparative Example 2: Epoxy Adhesive Manufactured by Pelnox Limited

A main agent EPOTACK (trade name) AD-45 contains a bisphenol A type epoxy resin and crystalline silica. A curing agent PELCURE (trade name) HQ-1W contains an aliphatic polyamine compound, triethylenetetramine, and titanium dioxide.

The mixing ratio of the main agent and the curing agent is 30 to 70 parts by mass of the curing agent with respect to 100 parts by mass of the main agent.

The working life of this adhesive at 25° C. was 120 minutes, and the bonding work was easily performed.

When the bonding state of the test piece after immersion in the sulfuric acid for one week was observed, it was found that the adhesive layer interface was corroded by the sulfuric acid. Further, when the peeling strength was measured, the interface between the plate-like member formed of ABS resin and the adhesive layer was peeled off, and the peeling strength was significantly reduced by immersion in the sulfuric acid. Also, when the bonding state of the test piece after immersion in the sulfuric acid for four weeks was observed, the bonding between the foil-like member formed of lead and the adhesive layer was not maintained.

### Comparative Example 3: Epoxy Adhesive 1500 Manufactured by Cemedine Co., Ltd

The main agent contains a bisphenol A type epoxy resin, and the curing agent contains a polyamidoamine compound.

In addition, the mixing ratio of the main agent and the curing agent is 100 parts by mass of the curing agent by mass with respect to 100 parts by mass of the main agent.

The working life of this adhesive at 25° C. was 60 minutes, and the bonding work was easily performed.

When the bonding state of the test piece after immersion in the sulfuric acid for one week was observed, it was found that the adhesive layer interface was corroded by the sulfuric acid. Further, when the peeling strength was measured, the interface between the plate-like member formed of ABS resin and the adhesive layer was peeled off, and the peeling strength was significantly reduced by immersion in the sulfuric acid. Also, when the bonding state of the test piece after immersion in the sulfuric acid for four weeks was observed, the bonding between the foil-like member formed of lead and the adhesive layer was not maintained.

### Comparative Example 4: Acrylic Adhesive SUPER X No. 8008 Manufactured by Cemedine Co., Ltd

The adhesive is a one component type adhesive containing acrylic-modified silicone.

The working life of this adhesive at 25° C. was 2 minutes, and the bonding work was less likely to be performed.

When the bonding state of the test piece after immersion in the sulfuric acid for one week was observed, the sulfuric acid did not infiltrate into the interface between the foil-like member formed of lead and the adhesive layer, and the bonding state was poor. Further, when the peeling strength was measured, the interface between the plate-like member formed of ABS resin and the adhesive layer was peeled off, and the peeling strength was significantly reduced by immersion in the sulfuric acid. Also, when the bonding state of the test piece after immersion in the sulfuric acid for four weeks was observed, the bonding between the foil-like member formed of lead and the adhesive layer was not maintained.

### Comparative Example 5: Double-Sided Pressure Sensitive Adhesive Tape Y-4914 Manufactured by 3M Japan Limited

The pressure sensitive adhesive used in the double-sided pressure sensitive adhesive tape is an acrylic pressure sensitive adhesive.

When the bonding state of the test piece after immersion in the sulfuric acid for one week was observed, it was found that the sulfuric acid infiltrated the interface between the foil-like member formed of lead and the pressure sensitive adhesive layer to cause the pressure sensitive adhesive layer to swell. The interface between the foil-like member formed of lead and the pressure sensitive adhesive layer was peeled off, and the bonding between the foil-like member formed of lead and the pressure sensitive adhesive layer was not maintained.

TABLE 1

| | | | | | Com. | Com. | Com. | Com. | Com. |
|---|---|---|---|---|---|---|---|---|---|
| | Unit | Ex. 1 | Ex. 2 | Ex. 3 | Ex. 1 | Ex. 2 | Ex. 3 | Ex. 4 | Ex. 5 |
| Main agent | | K-9487A | XNR3114 | XNR3106 | AV138 | AD-45 | 1500 | X8008 | Double-sided |
| | | | | | | | | | tape |
| Curing | | K-9487B | XNH3114 | XNH3103 | HV998 | HQ-1W | 1500 | — | — |
| agent | | | | | | | | | |
| Coefficient | ppm/K | 98 | 71 | 98 | 71 | 118 | 238 | 74 | — |
| of thermal | | | | | | | | | |
| expansion | | | | | | | | | |
| Glass | ° C. | 86 | 89 | 81 | 98 | 80 | 64 | −48 | 8 |
| transition | | | | | | | | | |
| temperature | | | | | | | | | |

The following is a list of reference signs used in this specification and in the drawing figures.
1 bipolar lead-acid battery
101 positive electrode lead layer
101a peripheral edge portion
101b peripheral edge tip end
102 negative electrode lead layer
103 positive active material layer
104 negative active material layer
105 electrolytic layer
110 negative electrode
111 substrate
120 positive electrode
130 bipolar electrode
140 adhesive layer
150 covering member
170 frame

What is claimed is:

1. A bipolar lead-acid battery comprising:
a bipolar electrode having a positive electrode formed on one surface of a substrate and a negative electrode formed on the other surface,
wherein the positive electrode includes a positive electrode lead layer that is formed of lead or lead alloy and disposed on the one surface of the substrate, a positive active material layer that is disposed on the positive electrode lead layer, and an adhesive layer that is disposed between the one surface of the substrate and the positive electrode lead layer and bonds the one surface of the substrate and the positive electrode lead layer,
the substrate is formed of a thermoplastic resin,
the adhesive layer is formed of a cured product of a reaction-curing type adhesive that is cured by a reaction between a main agent containing an epoxy resin and a curing agent containing an amine compound, and
even in a case where the adhesive layer is immersed in a sulfuric acid with a concentration of 38% by mass at a temperature of 60° C. for four weeks, the sulfuric acid does not infiltrate into an interface between the positive electrode lead layer and the adhesive layer.

2. The bipolar lead-acid battery according to claim 1, wherein
the thermoplastic resin is an acrylonitrile-butadiene-styrene copolymer or polypropylene.

3. The bipolar lead-acid battery according to claim 2, wherein
the epoxy resin is at least one of a bisphenol A type epoxy resin and a bisphenol F type epoxy resin.

4. The bipolar lead-acid battery according to claim 2, wherein
the amine compound is at least one of an aliphatic polyamine compound, an alicyclic polyamine compound, and an aromatic polyamine compound.

5. The bipolar lead-acid battery according to claim 2, wherein
a mixing ratio of the main agent and the curing agent in the reaction-curing type adhesive is 44 parts by mass or less of the curing agent with respect to 100 parts by mass of the main agent.

6. The bipolar lead-acid battery according to claim 2, wherein
the adhesive layer extends to a peripheral edge portion of a surface of both surfaces of the positive electrode lead layer on a side facing the positive active material layer, and comes into close contact with the peripheral edge portion to cover the peripheral edge portion.

7. The bipolar lead-acid battery according to claim 1, wherein
the epoxy resin is at least one of a bisphenol A type epoxy resin and a bisphenol F type epoxy resin.

8. The bipolar lead-acid battery according to claim 7, wherein
the amine compound is at least one of an aliphatic polyamine compound, an alicyclic polyamine compound, and an aromatic polyamine compound.

9. The bipolar lead-acid battery according to claim 7, wherein
a mixing ratio of the main agent and the curing agent in the reaction-curing type adhesive is 44 parts by mass or less of the curing agent with respect to 100 parts by mass of the main agent.

10. The bipolar lead-acid battery according to claim 7, wherein
the adhesive layer extends to a peripheral edge portion of a surface of both surfaces of the positive electrode lead layer on a side facing the positive active material layer, and comes into close contact with the peripheral edge portion to cover the peripheral edge portion.

11. The bipolar lead-acid battery according to claim 1, wherein
the amine compound is at least one of an aliphatic polyamine compound, an alicyclic polyamine compound, and an aromatic polyamine compound.

12. The bipolar lead-acid battery according to claim 11, wherein
a mixing ratio of the main agent and the curing agent in the reaction-curing type adhesive is 44 parts by mass or less of the curing agent with respect to 100 parts by mass of the main agent.

13. The bipolar lead-acid battery according to claim 11, wherein
the adhesive layer extends to a peripheral edge portion of a surface of both surfaces of the positive electrode lead layer on a side facing the positive active material layer, and comes into close contact with the peripheral edge portion to cover the peripheral edge portion.

14. The bipolar lead-acid battery according to claim 1, wherein
a mixing ratio of the main agent and the curing agent in the reaction-curing type adhesive is 44 parts by mass or less of the curing agent with respect to 100 parts by mass of the main agent.

15. The bipolar lead-acid battery according to claim 14, wherein
the adhesive layer extends to a peripheral edge portion of a surface of both surfaces of the positive electrode lead layer on a side facing the positive active material layer, and comes into close contact with the peripheral edge portion to cover the peripheral edge portion.

16. The bipolar lead-acid battery according to claim 1, wherein
the adhesive layer extends to a peripheral edge portion of a surface of both surfaces of the positive electrode lead layer on a side facing the positive active material layer, and comes into close contact with the peripheral edge portion to cover the peripheral edge portion.
